(19) United States
(12) Patent Application Publication
(10) Pub. No.: US 2004/0244118 A1
(43) Pub. Date: Dec. 9, 2004

(54) Combination swivel tool

(76) Inventors: Jon T. Cox, Riverton, WY (US); Richard L. Lookabaugh, Newport Beach, CA (US)

Correspondence Address: EDWIN S. WALL, WALL LAW OFFICES, 8 EAST BROADWAY, SUITE 500, SALT LAKE CITY, UT, 84111, US

(21) Appl. No.: 10/337,811

(22) Filed: Jan. 8, 2003

(51) Int. Cl. B26B 11/00

(52) U.S. Cl. 7/158; 7/156

(57) ABSTRACT

A combination swivel tool comprises an elongated tool member having first and second tool end portions located within a generally u-shaped housing. The elongated tool member defines a centrally located hole for receiving a swivel pin wherein the generally u-shaped housing member defining a plurality of swivel pin holes engages the elongated tool member when the swivel pin is inserted through the centrally located hole. The location and placement of the swivel pin allows the elongated tool member to swivel 360 degrees within the u-shaped housing. A handle member pivotally connected to the u-shaped housing member is provided for locking engagement of the elongated tool member within the u-shaped housing member exposing either the first or second tool end portions for use.

This invention relates to compound tools, and more specifically to a fixed bladed knife and tool combination.

Pocket-knives consisting of a handle or housing and of tools which can be swung out laterally of the housing and are securely locked in both their closed and opened positions by means of leaf springs coordinated thereto, are well known.

It is an object of the present invention to create a knife of this kind which is additionally provided with a tool end that can be comprised of additional blade designs, bottle openers, can openers, screwdrivers, wrenches or other tools by swiveling their ends 180 degrees.

This is accomplished according to the invention in that an elongated tool member having first and second tool end portions are located within a generally u-shaped housing. The elongated tool member defines a centrally located hole for receiving a swivel pin wherein the generally u-shaped housing member defining a plurality of swivel pin holes engages the elongated tool member when the swivel pin is inserted through the centrally located hole. The location and placement of the swivel pin allows the elongated tool member to swivel 360 degrees within the u-shaped housing. A handle member pivotally connected to the u-shaped housing member is provided for locking engagement of the elongated tool member within the u-shaped housing member exposing either the first or second tool end portions for use.

When the tool end is in its operative or opened position, the knife is housed within the handle member and vice a versa. Thus, the combination tool does not require a leaf spring or lateral folding out of tool portions as is well known in the prior art.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a side elevational view of the combination swivel tool in accordance with the present invention;

FIG. 2 shows a cut away side elevational view of another embodiment of the combination swivel tool of FIG. 1;

FIG. 3 is a cut away side elevational view illustrating a handle member position;

FIG. 4 is a side elevational view of the handle member of FIG. 3 engaging a swivel pin;

FIG. 5 is a partial cut away view detailing features of the locking mechanism of the handle member;

FIG. 6 illustrates a staionary flitted piece used for locking engagement;

FIG. 7 is a partial cut away side elevational view illustrating engagement of the swivel pin with the u-shaped member; and

FIG. 8 is a partial cut away view illustrating the locking engagement of the handle member with the u-shaped member in accordance with the present invention.

### DETAILED DESCRIPTION OF DRAWINGS

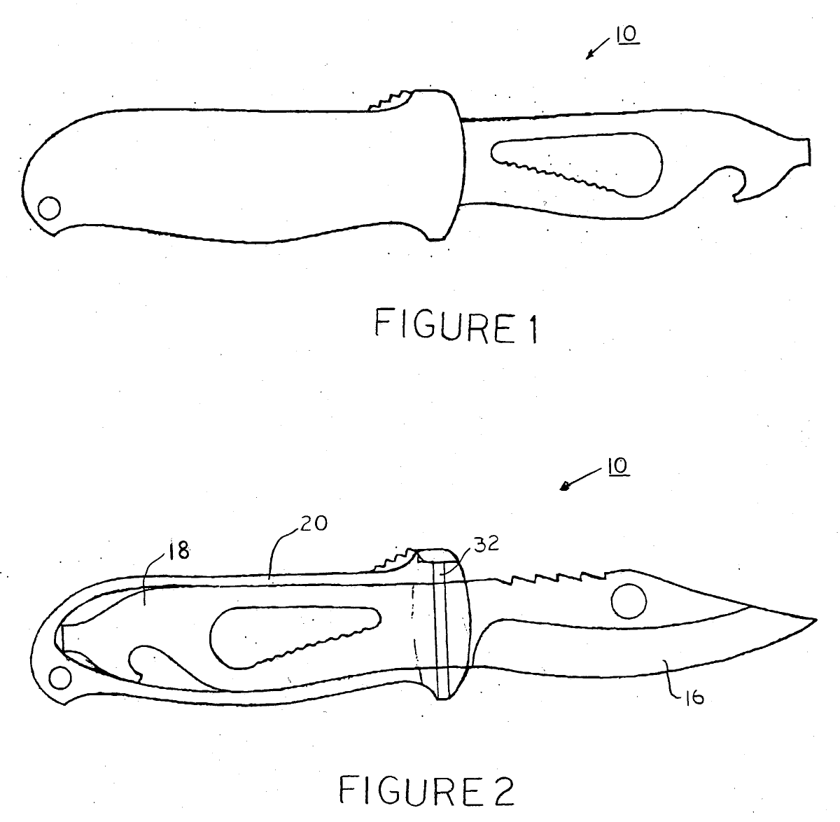

The present invention will now be described with reference numerals corresponding to like parts throughout the drawings. Referring now to FIGS. 1 and 2 there is shown the combination swivel tool 10 of the present invention comprising an elongated tool member 12 having a first end and 16 and an opposite second end 18 housed within a unshaped housing 20. The first and second end each define a tool portion, more specifically a knife blade 16 and in this instance a bottle or can opener 18. Referring once again to FIG. 2, the elongated tool member 12 defines a centrally located hole 32, for receiving a swivel pin, as will be more fully described below. It should be noted that the tool portions may me any of a variety of tools types, such as a screwdriver, allen wrench, corkscrew or the like.

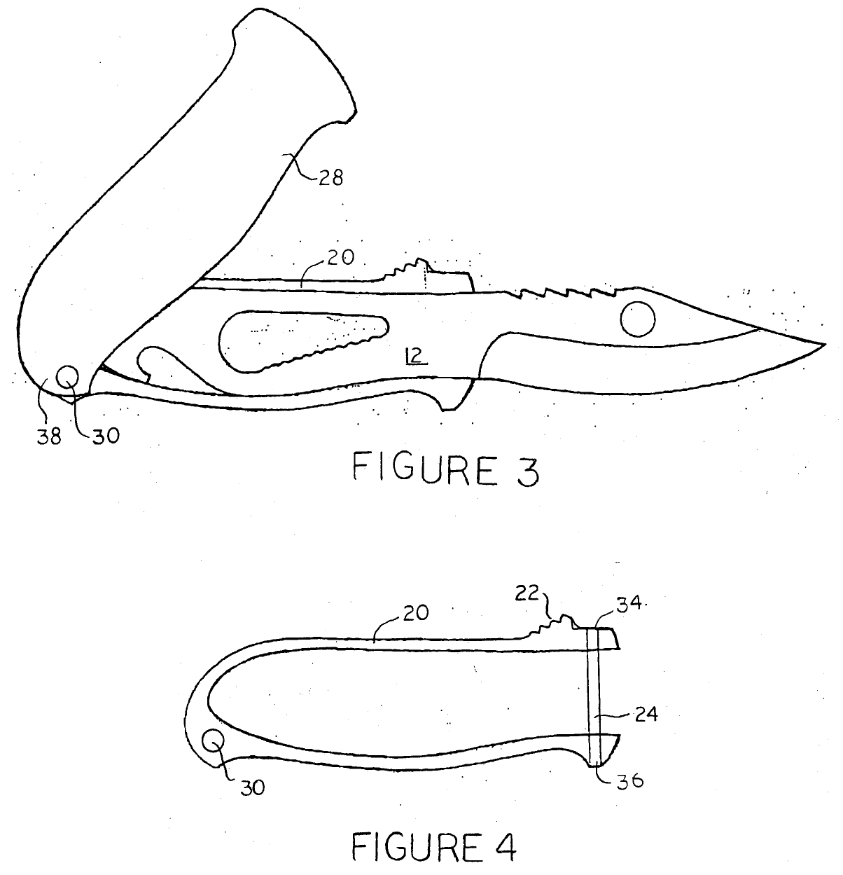

Referring now to FIGS. 3 and 4, the generally u-shaped housing member 20 is sized for receiving and housing a portion of the elongated tool member 12. More specifically, for housing either the knife portion 16 or the tool end portion 18. The u-shaped housing member 20 define a top 34 and a bottom 36 swivel pin hole for receiving swivel pin 24. In use, the elongated tool member 12 cooperatively engages the u-shaped housing 20 when the swivel pin 24 is inserted through the centrally located hole 32 and the top 34 and bottom 36 swivel pin holes. Utilizing the swivel pin 24 allows the elongated tool member 12 to swivel or rotate 360 degrees within the unshaped housing 20. Referring once again to FIG. 3, a handle member 28 pivotally connects at a bottom end 38 to the u-shaped housing member for locking engagement of the elongated tool member 12 within the unshaped housing member 20 as shown in FIG. 2. The handle member 28 is pivotally connected to the u-shaped member 12 by pivot pin and bushings 30.

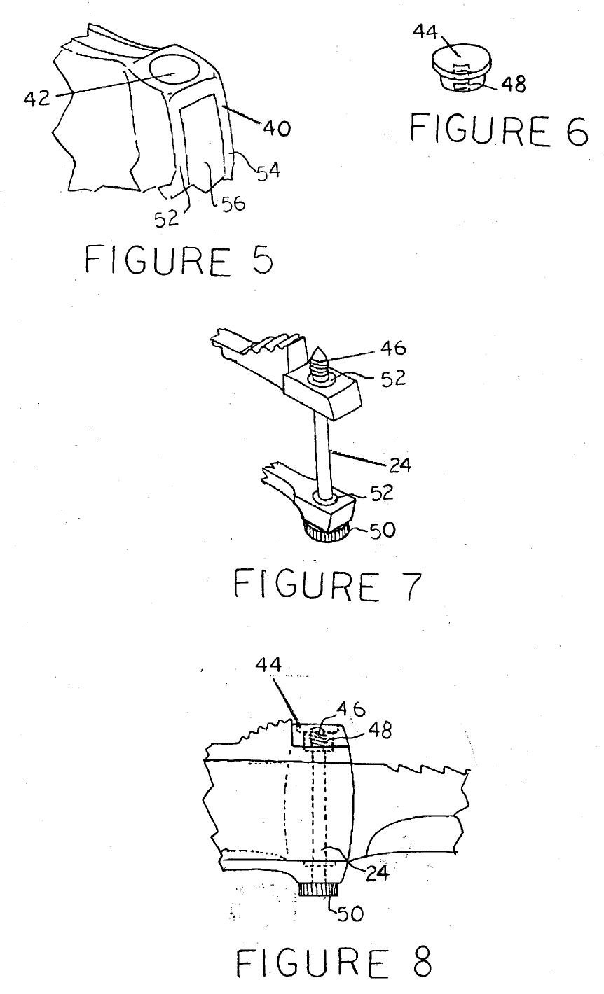

Referring to FIG. 5, the top end 40 of the handle member 28 defines a fitted piece hole 42 used for locking engagement. FIG. 6 shows a stationary fitted piece 44 for placement within the fitted piece hole 42. The fit may be of the type of interference fit that keeps the stationary fitted piece 44 permanently retained within the handle member 28. As shown in FIG. 7, the swivel pin 24 defines a threaded top portion 46 and a knurled knob bottom portion 50. The stationary fitted piece 44 defines threads 48 for engaging the threaded portion 46 of the swivel pin 24 when turning the knurled knob bottom portion 50 when the handle member 28 is in locking engagement. Additionally, swivel pin bushings 52 are press fit within the top 34 and bottom 36 swivel pin holes for ease of turning the swivel pin 24, as shown in FIG. 8.

Turning to FIG. 5, the handle member 28 has first and second sides 52 and 54 for defining a channel 56 such that when placed in locking engagement, is sized to receive the elongated tool member 12. When the handle member 28 is placed in locking engagement it combines with the u-shaped handle member 20 for uniformly defining all sides of a handle. In use, if the threaded top portion 46 is fully engaged then the handle member 28 has shut properly. If it is not fully engaged, the handle member 28 will not look, feel or be shut to the user. The u-shaped member 20 additionally defines a stepped top portion 22 for ease of use as shown in FIG. 4.

The previous description is provided to enable any person skilled in the art to make or use the present invention. The various modifications to the combination swivel tool will be readily apparent to those skilled in the art, and the generic principles defined herein may be applied to other embodiments without the use of the inventive faculty. Thus, the present invention is not intended to be limited to the description shown herein but is to be accorded the widest scope consistent with the principles and novel features disclosed herein.

1. A combination swivel tool comprising:
an elongated tool member having a first end and an opposite second end, said first and second end each defining a tool portion wherein said elongated member defining a centrally located hole for receiving a swivel pin;
a generally u-shaped housing member sized for receiving a portion of said elongated tool member and defining top and bottom swivel pin holes wherein said elongated tool member cooperatively engages said u-shaped housing when said swivel pin is inserted through said centrally located hole and said top and bottom swivel pin holes allowing said elongated tool member to swivel 360 degrees within said u-shaped housing; and
a handle member pivotally connected at a bottom end to said u-shaped housing member for locking engagement of said elongated tool member within said u-shaped housing member.

2. The combination swivel tool of claim 1 further comprising said tool portion of said first end of said elongated tool member is a knife blade.

3. The combination swivel tool of claim 1 further comprising said tool portion of said opposite second end of said elongated tool member is a bottle opener.

4. The combination swivel tool of claim 1 further comprising said swivel pin defining a threaded top portion and a knurled knob bottom portion.

5. The combination swivel tool of claim 4 further comprising a top end of said handle member defining a fitted piece hole used for locking engagement.

6. The combination swivel tool of claim 4 further comprising a stationary fitted piece placed within said fitted piece hole wherein said stationary fitted piece defines threads for engaging said threaded portion of said swivel pin when turning said knurled knob bottom portion when said handle member is in locking engagement.

7. The combination swivel tool of claim 5 further comprising bushings press fit within said top and bottom swivel pin holes for ease of turning said swivel pin.

8. The combination swivel tool of claim 6 further comprising said handle member having first and second sides, said first and second sides defining a channel such that when placed in locking engagement is sized to receive said elongated tool member for uniformly defining all sides of a handle while enclosing a portion of said elongated tool member.

9. The combination swivel tool of claim 1 further comprising said u-shaped member defining a stepped top portion for ease of use.

10. The combination swivel tool of claim 1 further comprising said handle member pivotally connected to said u-shaped member by a pivot pin and bushings.

11. A combination swivel tool comprising:
an elongated tool member having a first end and an opposite second end, said first and second end defining a knife and a can opener respectively, wherein said elongated member further defines a centrally located hole for receiving a swivel pin;
a generally u-shaped housing member sized for receiving a portion of said elongated tool member and defining top and bottom swivel pin holes wherein said elongated tool member engages said u-shaped housing when said swivel pin is inserted through said centrally located hole and said top and bottom swivel pin holes allowing said elongated tool member to swivel 360 degrees within said u-shaped housing; and
a handle member pivotally connected at a bottom end to said u-shaped housing member for locking engagement of said elongated tool member within said u-shaped housing member.

12. The combination swivel tool of claim 11 further comprising said swivel pin defining a threaded top portion and a knurled knob bottom portion.

13. The combination swivel tool of claim 12 further comprising a top end of said handle member defining a fitted piece hole used for locking engagement.

14. The combination swivel tool of claim 13 further comprising a stationary fitted piece placed within said fitted piece hole wherein said stationary fitted piece defines threads for engaging said threaded portion of said swivel pin when turning said knurled knob bottom portion when said handle member is in locking engagement.

15. The combination swivel tool of claim 16 further comprising bushings press fit within said top and bottom swivel pin holes for ease of turning said swivel pin.

16. The combination swivel tool of claim 15 further comprising said handle member having first and second sides, said first and second sides defining a channel such that when placed in locking engagement is sized to receive said elongated tool member for uniformly defining all sides of a handle while enclosing a portion of said elongated tool member.

17. The combination swivel tool of claim 16 further comprising said u-shaped member defining a stepped top portion for ease of use and said handle member pivotally connected to said u-shaped member by a pivot pin and bushings.

18. A combination swivel tool comprising:
an elongated tool member having a first end and an opposite second end, said first and second end defining a knife and a can opener respectively, wherein said elongated member further defines a centrally located hole for receiving a swivel pin, said swivel pin defining a threaded top portion and a knurled knob bottom portion;
a generally u-shaped housing member sized for receiving a portion of said elongated tool member and defining top and bottom swivel pin holes wherein said elongated tool member engages said u-shaped housing when said swivel pin is inserted through said centrally located hole and said top and bottom swivel pin holes allowing said elongated tool member to swivel 360 degrees within said u-shaped housing;
a handle member pivotally connected at a bottom end to said u-shaped housing member and a top end of said handle member defining a fitted piece hole used for locking engagement;
a stationary fitted piece placed within said fitted piece hole wherein said stationary fitted piece defines threads for engaging said threaded portion of said swivel pin when turning said knurled knob bottom portion when said handle member is in locking engagement; and
said handle member having first and second sides, said first and second sides defining a channel such that when placed in locking engagement is sized to receive said elongated tool member for uniformly defining all sides of a handle while enclosing a portion of said elongated tool member.

19. The combination swivel tool of claim 18 further comprising said u-shaped member defining a stepped top portion for ease of use.

20. The combination swivel tool of claim 19 further comprising said handle member pivotally connected to said u-shaped member by a pivot pin and bushings.
